(19) United States
(12) Patent Application Publication
(10) Pub. No.: US 2003/0229672 A1
(43) Pub. Date: Dec. 11, 2003

(54) Enforceable spam identification and reduction system, and method thereof

(76) Inventor: Daniel Mark Kohn, Palo Alto, CA (US)

Correspondence Address: Elliot Furman, Skymoon Ventures, 3045 Park Blvd., Palo Alto, CA, 94306, US

(21) Appl. No.: 10/163,842

(22) Filed: Jun. 5, 2002

(51) Int. Cl. G06F 15/16

(52) U.S. Cl. 709/207

(57) ABSTRACT

A method for enforceably reducing spam comprises checking an email message for a specific mark and if the specific mark is present, tagging the email message as non-spam. The tagged email is displayed to a user of a local computer. The specific mark may be displayed with the tagged email. The mark is part of an enforceable anti-spam email header field comprising a field name and a field body. The field body comprises the mark which is used for identification or indication of ownership. The mark is legally reserved for the exclusive use of the owner of the mark. If the user identifies the tagged email as spam, the tagged email is sent to a remote enforcement computer.

### BACKGROUND

Spam is email which is either commercial, or sent to multiple recipients, or both, the transmission of which is without the express permission of one or more of the recipients. A sender may send out tens to tens of thousands of spam emails to computer users in an attempt to advertise and sell a product or service. Spammers typically target as many email recipients as possible since the incremental cost of sending additional emails is very low or nil.

The amount of spam received by computer users has been increasing as more and more people “go online.” A computer user with any sort of presence on the Internet can easily receive thirty or more spam emails per day. Jupiter Communications estimates that each American will receive 768 spam messages this year. Spam is a nuisance to users, clogging up email inboxes and distracting users from their important, personal, and solicited emails.

More than an annoyance, spam costs American businesses and users money. It can easily take ten minutes per workday to sort through all of a user's spam. With 300 million email users at $15/hour on average, over $200 billion worth of time is wasted per year. According to an article in Business Week (Mar. 1, 2002), “Computer Mail Services, a Southfield (Mich.) technology company, has created a calculator that projects the cost of spam. It shows that a company with 500 employees, each of whom receives five junk emails per day and spends about 10 seconds deleting each one, can expect to lose close to $40,000 per year in wasted salaries and 105 days in lost productivity.”

Spam also wastes tangible resources relied upon by Internet service providers (ISPs) such as bandwidth, ISP disk space, user email storage space, networking and computer resources, and the like. In some instances spam can bring down servers, amounting to the equivalent of an unintended denial of service attack. In order to handle the immense and growing volume of email, ISPs and email providers must continually maintain, upgrade, and purchase improved, more powerful, and greater numbers of computers and networking resources. Thus spam represents a further drain on the efficiency and profitability of ISPs and email providers.

Spam unmistakably represents an enormous problem to users and businesses alike. Many techniques, services, and software products are being used on both the user (or client) side, and server side (located at the ISP or email provider) to reduce the volume of spam a user receives. Spam can be identified and filtered by the mail server so it is never sent to the user. Alternatively, the spam may be sent to the user but may be tagged as potential spam so that it is routed to a folder other than the user's inbox. This allows a user to view the potential spam if desired while keeping the inbox clear of spam. Additionally, email may be filtered by software on the user's computer so that spam is automatically deleted or the spam is routed to a folder other than the user's inbox.

Some of the more popular and effective spam filtering systems employ rule-based techniques in software running on the server side, the user side, or both. Such software analyzes incoming email by looking for specific phrases and words in the body, or content, portion of the email (the portion of the email containing the information intended to be delivered to the recipient). The software further identifies problematic fields and field content in the header, or envelope, portion of the email (the portion that contains whatever information is needed to accomplish the transmission and delivery of the email). The analyses result in a score, and the score is compared to a threshold that is configurable by a user or system administrator. If the score exceeds the threshold, the software marks the email as spam and deals with it as discussed above.

Other spam reduction techniques that are used either separately or in addition to rule based systems such as described above employ blacklists and spam tracking databases. Blacklists and spam tracking databases store lists of Internet addresses from known spammers and databases of spam sent in by spam recipients. Spam filtering software running on a server or user's computer utilizes these lists by comparing incoming email with the databases and, if a match is found, tagging the email as spam.

Examples of software and services that employ one or more of the techniques described above are SpamAssasin (http://spamassassin.org), Vipul's Razor (http://razor.sourceforge.net), the Open Relay Database (http://www.ordb.org), and the Mail Abuse Prevention System (http://www.mail-abuse.org). Furthermore, many ISPs and email service providers, such as Earthlink and Yahoo! Mail, employ one or more of the above techniques to limit the amount of spam delivered and displayed to their users.

While the above techniques, especially when used in combination, are somewhat effective in reducing spam, a user is still likely to receive spam. The reasons for this are twofold: 1. It is impossible to have a complete up-to-the-minute database of all spammers, and 2. Spam filters cannot be set tight enough to avoid false negatives (spam email identified as non-spam email) without generating too many false positives (non-spam email identified as spam email). Furthermore, email that a user has specifically requested to receive on an opt-in basis may be tagged as spam as these emails share many of the same characteristics as spam. There is no mechanism for a sender to authoritatively warrant that their message is not spam.

More importantly, none of the spam reduction techniques discussed above discourages spammers from sending out unsolicited emails. To the contrary, spammers have incentive to spam even more aggressively in an attempt to circumvent spam filtering software and services, as well as to reach users who are not employing spam filtering tools. Further exacerbating the problem, there are few enforceable local, state, or federal laws in the United States prohibiting spamming. While it would be advantageous to consumers and many businesses if there were effective laws prohibiting spamming, powerful special interest groups such as the Direct Marketing Association fiercely oppose such laws. Consequently, it remains very difficult to enact effective legislation that would for example allow spam recipients to sue spammers.

Thus a need presently exists for an improved system and method for enforceably identifying and reducing spam.

### SUMMARY

By way of introduction, the preferred embodiments provide an enforceable spam identification and reduction system, and method thereof. An enforceable anti-spam header field comprises a field name and a field body corresponding to the field name. The field body comprises a mark, such as a trademark, servicemark, or copyright. Providing an email message, the enforceable spam reduction method, which may be computer implemented, comprises checking the email message for a specific mark, and if the email message comprises the specific mark, tagging the email message as non-spam email. Checking the email message, which comprises a header portion, further comprises checking the header portion for a specific enforceable anti-spam email header field. If the header portion comprises the specific enforceable anti-spam email header field, it is determined if the specific enforceable anti-spam email header field comprises the specific mark. If the specific mark is present, the email is tagged as non-spam email. Tagged email is displayed to a computer user to whom the email message was addressed thereby allowing the user to read the email message. If upon seeing the email message, the computer user determines the email message to be spam, the email message is forwarded to a remote enforcement computer.

The foregoing paragraph has been provided by way of general introduction, and it should not be used to narrow the scope of the following claims. The preferred embodiments will now be described with reference to the attached drawings.

### BRIEF DESCRIPTION OF THE DRAWINGS

FIG. 1 is a computer network for sending and receiving email messages.

FIG. 2 is an illustration showing an exemplary email “Inbox”.

FIG. 3 is a flowchart showing a method for enforceably identifying and reducing spam.

### DETAILED DESCRIPTION OF THE PRESENTLY PREFERRED EMBODIMENTS

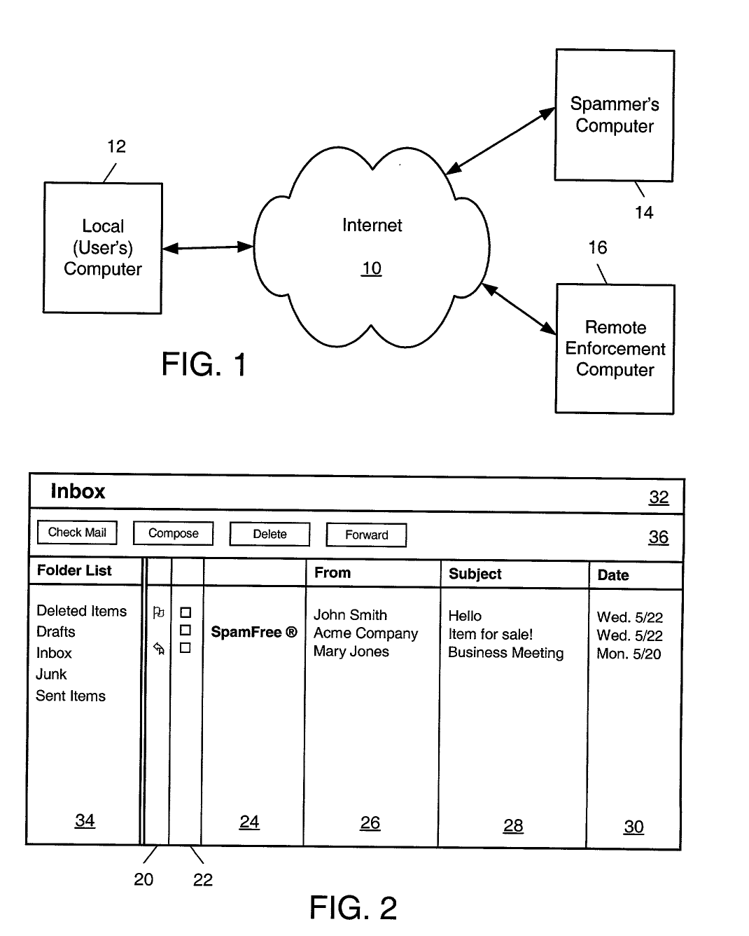

FIG. 1 shows an exemplary computer network for sending and receiving email messages. Local computer 12, spammer computer 14, and remote enforcement computer 16 are connected to a communications network, such as the Internet 10. A spammer uses a computer, such as spammer computer 14, to send out unsolicited email, or spam, via the Internet 10. Local computer 12 receives this spam along with possibly tens to greater than tens of thousands of other users (not shown) connected to the Internet 10.

Computers like local computer 12 may be connected to the Internet 10 via a modem such as a dial up modem, a DSL modem, a cable modem, or any other type of modem compatible with the network. Also, local computer 12 may be part of another network, such as a wireless network, a corporate network, a local area network, and a wide area network that itself is in communication with the Internet 10, thereby allowing local computer 12 to send and receive email from other computers and devices connected to the Internet 10.

Local or user's computer 12 may be a desktop or laptop computer located in the home or business of a user. Additionally, local computer 12 can be any number of computing devices operative to send and receive email such as personal digital assistants, pagers, cell phones, and computing devices integrated with home entertainment systems. Often, local computer 12 is connected to the Internet 10 via a mail server (not shown) that receives email from the Internet 10 and routes the email to the appropriate user's computer 12 in communication with the mail server. When referring to software running on a local computer it is appreciated by those skilled in the art that the software can equivalently be executed on a mail server or any other device operative to deliver email messages directly to the user's computer.

As will be discussed, local computer 12 executes software that allows local computer 12 to identify and block spam. Moreover, the software and techniques employed to identify spam empower a third party in control of remote enforcement computer 16 to take legal action against the spammer using spammer computer 14 under existing U.S. and international trademark and copyright laws. For that reason, the system and method are termed enforceable, since in addition to blocking spam, an enforcement means is created for punishing spammers by way of existing laws. The terms “mark” and “registered mark” are broadly defined to mean a device, such as a word, phrase, or symbol, used for identification or indication of ownership and legally reserved for the exclusive use of the owner. Trademarks, servicemarks, copyrights, registered trademarks, registered servicemarks, and registered copyrights are all marks. Computer generated icons and patented computer generated icons are also marks.

The software at local computer 12 scans incoming email messages for a specific mark. The specific mark is the property of a person or entity other than the spammer and user at local computer 12. The owner of the mark may be the remote user at remote enforcement computer 16. Alternatively, the remote user at remote enforcement computer 16 may not own the mark but may be employed by the owner of the mark to enforce the mark.

If upon scanning the incoming email the specific mark is found to be present within the email, the email is tagged as legitimate, or non-spam email. Tagged email is displayed to the user on local computer 12. If upon reading the email the user ascertains that the email is actually spam, the user prompts the local computer to transmit, or forward, the email to the remote enforcement computer 16.

Those of ordinary skill in the art will understand that the only way an email can be tagged as non-spam email is if the email contains the specific mark. Therefore, spammers using the specific mark without the permission of the mark owner are illegally violating the mark and the laws governing it. Furthermore, the illegal use of the mark severely diminishes the value of the mark in that the presence of the mark itself indicates to the user that the email is not spam and can be trusted. This will be illustrated in greater detail below.

Email is comprised of a content or body portion, and a header or envelope portion. The body is the portion of the email comprising the information intended to be delivered to the recipient. The header is the portion that comprises whatever information is needed to accomplish the transmission and delivery of the email. The header is further comprised of fields, and a field is comprised of a field name and a field body. For example, a simple email is shown below. Line numbers are shown to the right of each line in parentheses for reference:

| | |
|---|---|
| From: Bill Smith <bsmith@machine.example> | (1) |
| To: Jane Doe <jdoe@example.net> | (2) |
| Subject: Hello | (3) |
| Message-ID: <1234@local.machine.example> | (4) |
| | (5) |
| Hello. How are you? | (6) |

Lines 1-4 make up the header and line 6 is the body. In this particular example there are four fields in the header: “From”, “To”, “Subject”, and “Message-ID”. Examining an individual field, line 3 shows the subject field; “Subject” is the field name and “Hello” is the field body. Many additional fields are possible. The Internet Engineering Task Force (IETF) Request For Comments (RFC) 2822 document, which is hereby incorporated by reference, is a standard that specifies a syntax (including fields) for text messages that are sent between computer users, within the framework of “electronic mail” messages.

The present invention provides an enforceable anti-spam email header field comprising a field name and field body associated with the field. The field body comprises a mark as defined above. To remain compliant with IETF RFC 2822 the field name is separated from the field body by a colon, and the number of characters of the email header line is up to 998 characters. To further ensure compliance, the number of characters of the email header line may be additionally limited to no more than 78 characters. An exemplary enforceable anti-spam email header field is:

X-PoetryNotSpam: SpamFree (Registered Trademark)

In this example, the field name is “X-PoetryNotSpam” and the field body is “SpamFree (Registered Trademark)”. Those of ordinary skill in the art will readily appreciate that many other names may be used for the field name and many other registered trademarks may be used for the field body. Another exemplary enforceable anti-spam email header field comprises a copyrighted “poem” as follows:

X-PoetryNotSpam: Congress won't enact

X-PoetryNotSpam: A private right to action

X-PoetryNotSpam: So use copyright

X-PoetryNotSpam: Sender-Warranted Whitelist—The sender of this email, in exchange for a license for applicable copyright, trademark, and patent protection, warrants that this message is not unsolicited bulk email (UBE, or spam). Contact www.PoetryNotSpam.com to report the use of this header on spam.

X-PoetryNotSpam: Copyright 2002 Poetry Not Spam(tm)

This is an example of using a multi-line copyright as an enforceable anti-spam email header field. Registered trademarks, copyrights, and other marks can be used in combination with each other as well. To ensure email sent to a user will be tagged as non-spam the sender of the email message includes one or more of the above or equivalent enforceable anti-spam email header fields along with the other header information transmitted with the email. For example, below is an enforceable anti-spam email header (lines 1-5). The enforceable anti-spam email header field is shown in line 5:

| | |
|---|---|
| From: Bill Smith <bsmith@machine.example> | (1) |
| To: Jane Doe <jdoe@example.net> | (2) |
| Subject: Hello | (3) |
| Message-ID: <1234@local.machine.example> | (4) |
| X-PoetryNotSpam: SpamFree (Registered Trademark) | (5) |
| | (6) |
| Hello. How are you? | (7) |

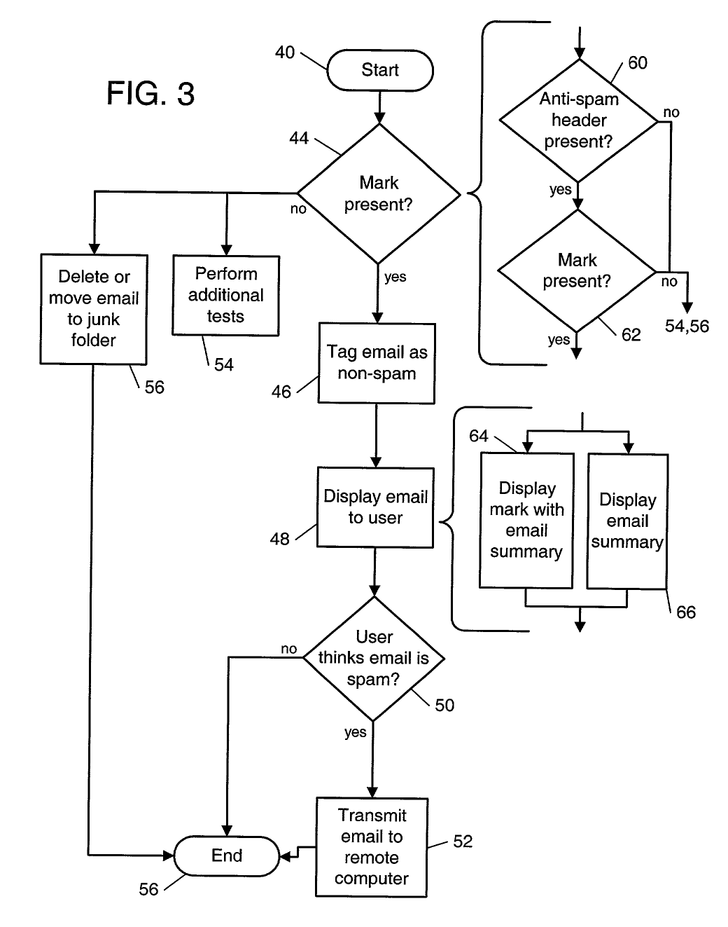

Referring to FIG. 3, the details of a method for enforceably identifying and reducing spam is shown. The method may be implemented as computer code stored in the memory of a computer and running on the computer processor to perform the operations disclosed. Also, a computer readable medium may be encoded with executable computer code representative of the method.

It is noted that the method illustrated in FIG. 3 may be used in conjunction with many of the prior art spam detection and filtering methods discussed above. For example, a rule based filtering system can analyze incoming email prior to the start (step 40) of the enforceable spam reduction method.

Upon receiving or providing an email comprising an email header, the email is scanned for a specific mark (step 44). This includes checking the header portion of the email for a specific enforceable anti-spam header field (step 60) or a portion thereof, and if the header portion contains the specific enforceable anti-spam header field or an identifiable portion thereof, determining if the anti-spam header field contains the specific mark (step 62).

If the email message comprises the specific mark the email is tagged as non-spam email (step 46) and the email is displayed at the user's computer (step 48). The displaying includes displaying to the computer user a summary of the email message which may comprise email sender, email subject, and email data, and possibly other header information (step 66). The displaying further includes displaying the specific mark along with the email summary.

Upon displaying the email to the user, if the computer user determines the email message to be spam (step 50), the email message is forwarded, manually or automatically, to a remote enforcement computer (step 52). Otherwise the process ends (step 56).

Referring back to steps 44, 60, and 62, if the email message does not contain the specific mark, the email may be deleted or placed in a temporary “mailbox” such as a “junk” mailbox (step 56) depending on the software's configuration and user's preferences. Alternatively, the email may be further processed to determine if the email is spam (step 54). This processing may include using some of the prior art systems and methods discussed above.

In general, computer users read their email by using programs such as Microsoft's Outlook, or via an Internet web-browser in conjunction with web-based email services such as Yahoo! Mail or Microsoft Hotmail. FIG. 2 shows an exemplary view of an email inbox from one of these email programs or web based email services. FIG. 2 is not intended to represent any particular email program or service but is rather intended to serve as an example of a typical interface or view. Most email programs and services will display at least some of the information shown in FIG. 2., although the layout will vary from program to program.

Referring to FIG. 2, the “Inbox” of the user's email is displayed as is represented by panel 32. The user can switch between different folders such as “Deleted Items” and “Junk” by selected the desired folder in panel 34. The user can read an email message by selecting the desired email from the list displayed in panels 26, 28 and 30. Panel 36 comprises buttons “Check Mail,” “Compose,” “Delete,” and “Forward.” Selecting may be accomplished via any conventional means, for example with a computer mouse.

The inbox displays a summary of email messages as well as the status of those email messages. For example, email sender (panel 26), email subject (panel 28), and email date (panel 30) are shown as part of the email summary information. Additionally, email status (panel 20) showing whether the email is flagged, as indicated by the flag symbol in panel 20, or if the email has been replied to, as indicated by the curved arrow in panel 20, is displayed. Panel 22 comprises check boxes for each email message for selecting an email message and performing an action, such as “Delete” or “Forward” on the email.

Panel 24 displays the specific mark received with email, if such mark is received. The marks displayed in panel 24 warrants to the computer user that the email is not spam. Particularly, in FIG. 2 the user has received an email from “Acme Company” as shown in panel 26. Presumably, the user had specifically requested, or opted-in, to receive emails from Acme Company. Acme Company included a specific mark, SpamFree®, as part of an enforceable anti-spam email header field in their email. The enforceable anti-spam software running at the local or user's computer detected the specific mark and tagged the email as non-spam email, as explicated above. As such, the specific mark “SpamFree®” is displayed (panel 24) along with a summary of the Acme Company email (email sender “Acme Company” (panel 26), email subject “Item for sale!” (panel 28), and email date “Wed May 22” (panel 30)).

Other means for indicating to the user that an email is not spam may be used. For example, the email summary for the non-spam email may be displayed in a different font. Or the summary line of the non-spam email may be highlighted with a color. Or different symbols, designs, and icons may displayed in panel 24 or elsewhere. These symbols, designs, and icons may be protected under trademark, copyright, and patent laws. Also, the specific mark may be displayed as part of the body of the email when the user reads the email.

If upon viewing the Acme Company email summary or reading the Acme Company email the computer user determines that the Acme Company email is spam, the user can forward the email to the remote enforcement computer 16 of FIG. 1 by selecting the appropriate check box in panel 22 and choosing the forward button in panel 36. The forward button in panel 36 may be configured to forward all selected email messages to the remote enforcement computer 16 with a single mouse click. As discussed above, the remote user of remote enforcement computer 16 can then pursue legal action against Acme Company, or whoever is illegally using the mark, under existing trademark, copyright, or patent infringement laws. For example upon receiving forwarded spam email from local computer 12, the remote enforcement computer 16 might automatically send a cease and desist letter to the sender of the spam email and spammer's computer 14.

Verified opt-in emailers are emailers that verify that a request which is made to subscribe an email address to an email list was made by the user who properly has control of the email address, and that the user intended to and wanted to sign up for the email list. There are several ways to verify an account such as closed loop confirmation, where a subscription request is made for an email address, and the list owner or manager sends a confirmation email which requires some affirmative action on the part of the owner of the email address before the email address is added to the mailing list. Verified opt-in is also known as “confirmed opt-in”, “fully-confirmed opt-in”, “fully-verified opt-in”, “closed-loop opt-in”, and “double opt-in”.

The owner of the mark, such as SpamFree®, may for example license the use of the mark to verified opt-in emailers. In such a scenario the emailer may have to pay the owner a royalty for every email they transmit with the mark. This has the effect of discouraging the verified opt-in emailer from sending out mass unsolicited emails as each email costs the emailer money. Additionally, the misuse of the mark, such as embedding the mark within email sent to users who have not opted-in, may result in the emailer losing their license to the mark, and may also result in legal action against the emailer under existing trademark, copyright, and patent laws.

Further, the owner of the specific mark may for example offer a perpetual and royalty-free license to all mail programs such as Microsoft's Outlook and Yahoo! Mail to include the specific mark in all email messages with less than, for example, ten recipients. This ensures that individuals merely emailing friends or family will not have their email blocked. Additionally, a license may also be granted to companies supplying other anti-spam software and services such as those discussed above like SpamAssassin and BrightMail. This license may be royalty free at first to encourage adoption.

As discussed, other anti-spam software may be used in conjunction with the present invention. When used in combination, the threshold discussed above in connection with rule based anti-spam software can be set significantly lower. Email messages classified by the rule based system as spam but containing the specific anti-spam header field will be whitelisted by the present invention so as to allow them to be tagged as non-spam.

The foregoing detailed description has discussed only a few of the many forms that this invention can take. It is intended that the foregoing detailed description be understood as an illustration of selected forms that the invention can take and not as a definition of the invention. It is only the following claims, including all equivalents, that are intended to define the scope of this invention.

What is claimed is:

1. An enforceable anti-spam email header field comprising:
a field name; and
a field body corresponding to the field name, said field body comprising a mark.

2. The invention of claim 1 wherein said field name is separated from said field body by a colon, and wherein the number of characters of the email header field is up to 998 characters.

3. The invention of claim 2 wherein the number of characters of the email header field is up to 78 characters.

4. The invention of claim 1 wherein said mark is a registered mark.

5. The invention of claim 1 wherein said mark is a patented computer-generated icon.

6. The invention of claim 1 wherein said mark is a member of the group consisting of trademarks, registered trademarks, copyrights, registered copyrights, servicemarks, and registered servicemarks.

7. The invention of claim 1 wherein said field name is “X-PoetryNotSpam”.

8. The invention of claim 1 wherein said field body is “SpamFree (Registered Trademark)”.

9. The invention of claim 1 wherein said field name and said field body are in compliance with the internet engineering task force request for comments 2822 document.

10. An enforceable spam reduction computer implemented method, the method comprising:
(a) providing an email message;
(b) checking the email message for a specific mark; and
(c) if the email message comprises the specific mark, tagging the email message as non-spam email.

11. The invention of claim 10 further comprising if the email message does not comprise the specific mark, deleting the email message.

12. The invention of claim 10 further comprising if the email message does not comprise the specific mark, performing additional tests to determine if the email message is spam.

13. The invention of claim 10 wherein the email message comprises a header portion and a body portion, and wherein (b) comprises:
(b1) checking the header portion for a specific enforceable anti-spam email header field; and
(b2) if the header portion comprises the specific enforceable anti-spam email header field, determining if the specific enforceable anti-spam email header field comprises the specific mark.

14. The invention of claim 10 further comprising:
(d) displaying the email message tagged as non-spam email to a computer user to whom the email message was addressed so as to allow the user to read the email message; and
(e) if the computer user determines the email message to be spam, forwarding the email message to a remote enforcement computer.

15. The invention of claim 14 wherein said displaying in (d) further comprises:
(d1) displaying a summary of the email message; and
(d2) displaying with the summary the specific mark.

16. A method to enforceably identify and reduce spam comprising:
(a) receiving an email message comprising a header at a local computer;
(b) scanning the email message header for a specific mark;
(c) if the specific mark is present in the email header, tagging the email message as non-spam, and displaying the email message to a computer user; and
(d) if the computer user identifies the email message as spam, sending the email message to a remote enforcement computer.

17. The invention of claim 16 further comprising if the specific mark is not present in the email header, deleting the email message.

18. The invention of claim 16 further comprising if the specific mark is not present in the email header, performing additional tests to determine if the email message is spam.

19. The invention of claim 16 wherein said displaying in (c) further comprises:
(c1) displaying a summary of the email message; and
(c2) displaying with the summary the specific mark.

20. A system for enforceably reducing spam email:
means for receiving an email message comprising a header;
means for scanning the email message header for a specific mark;
means for tagging the email message as non-spam, and means for displaying the tagged email message to a computer user if the specific mark is present in the email message header; and
means for sending the email message to a remote enforcement computer if the computer user identifies the email message as spam.

21. The invention of claim 20 wherein said means for displaying further comprises:
summary display means for displaying a summary of the email message; and
mark display means for displaying with the summary the specific mark.

22. A computer-readable medium having stored thereon instruction for enforceably identifying and reducing spam which, when executed by a processor, causes the processor to perform the steps of:
(a) scanning an email message for a specific mark;
(b) if the specific mark is present in the email message, tagging the email message as non-spam, and displaying the email message to a computer user; and
(c) if the computer user identifies the email message as spam, sending the email message to a remote enforcement computer.

23. The invention of claim 22 wherein said displaying in (b) further comprises:
(b1) displaying a summary of the email message; and
(b2) displaying with the summary the specific mark.

24. A computer program product for enforceably determining if an email message comprising an email header is spam, the program product comprising:
a computer readable medium;
scanning means stored on said computer readable medium for scanning the email for a specific mark;
tagging means stored on said computer readable medium for tagging the email message as non-spam if the specific mark is present;
displaying means stored on said computer readable medium for displaying the email message to a computer user if the email message is tagged as non-spam; and
sending means stored on said computer readable medium for sending the email to a remote enforcement computer if the computer user identifies the email message as spam.

25. The invention of claim 24 wherein said scanning means comprises header scanning means for scanning the email header.

26. The invention of claim 24 wherein said displaying means comprises:
summary display means for displaying a summary of the email message; and
mark display means for displaying with the summary the specific mark.
